(19) United States
(12) Patent Application Publication
(10) Pub. No.: US 2025/0377707 A1
(43) Pub. Date: Dec. 11, 2025

(54) Power Efficiency Techniques for Devices

(71) Applicant: Apple Inc., Cupertino, CA (US)

(72) Inventors: Nikhil Sharma, Sunnyvale, CA (US); Stefan Angelevski, Seattle, WA (US); Venu M. Duggineni, Sunnyvale, CA (US); Varadharajan Chandran, Sunnyvale, CA (US); Derek L. Heard, Sunnyvale, CA (US); Clifford E. Russell, Vancouver (CA); David M. Jun, Boulder, CO (US); Chandrika Parimoo, Sunnyvale, CA (US); Alexander J. Court, Erie, CO (US); Bo Zhou, Cupertino, CA (US); Lucas D. Frye, Boulder, CO (US); Yuqing Su, Santa Clara, CA (US)

(21) Appl. No.: 19/230,499

(22) Filed: Jun. 6, 2025

Related U.S. Application Data
(60) Provisional application No. 63/657,733, filed on Jun. 7, 2024.

(51) Int. Cl. G06F 1/3215; G06F 1/3234; G06F 1/3287

(52) U.S. Cl. CPC G06F 1/3215; G06F 1/3243; G06F 1/325; G06F 1/3287

(57) ABSTRACT

Techniques are disclosed relating to managing power efficiency in devices. In various embodiments, an active driver system determines power states of device components based on operational state transitions detected by drivers executing within a first system-on-chip (SoC). The system involves activating or deactivating components integrated within a second SoC based on the power needs ascertained by the corresponding drivers managing the components. The system also involves activating or deactivating the second SoC based on the power states of the components integrated within the second SoC. The drivers provide instructions to manage power states dynamically, allowing for the conservation of energy by deactivating components when not required.

The present application claims priority to U.S. Prov. Appl. No. 63/657,733, entitled “Power Efficiency Techniques for Devices,” filed Jun. 7, 2024, which is incorporated by reference herein in its entirety.

### BACKGROUND

### Technical Field

This disclosure relates generally to solutions for managing power consumption, and, more specifically, to power efficiency techniques for devices.

### Description of the Related Art

A battery-powered device can include one or more processors capable of executing computationally expensive tasks. By way of example, a computationally expensive task can demand significant energy which can lead to rapid battery depletion. Existing power management techniques typically involve static power control schemes where components are either fully operational or completely turned off. In some aspects, these methods do not account for the dynamic nature of a battery-powered device where the need for processing power can fluctuate based on user interaction and application requirements. Accordingly, there is a need for more adaptive power management methods that can extend battery life by adjusting the power states of one or more processors and other components based on various operational states of the battery-powered device.

### BRIEF DESCRIPTION OF THE DRAWINGS

FIG. 1 is a block diagram illustrating an active driver-based system for powering and managing components within a device, according to some embodiments.

FIG. 2 is a block diagram illustrating a dual system on a chip (SoC) configuration in a battery-powered device, according to some embodiments.

FIG. 3 is a flow diagram illustrating a dual SoC management system for dynamic control of component power states based on operational demands, according to some embodiments.

FIGS. 4A-4C are flow diagrams illustrating methods for powering and managing components within a battery-powered device, according to some embodiments.

FIG. 5 is an example of a wearable device for implementing techniques described herein.

### DETAILED DESCRIPTION

A device can consume a considerable amount of power due to the demands of continuous software processing, the various sensors and hardware components within the device, etc. In some aspects, traditional power management techniques can involve a passive approach where components are either fully powered on or completely shut off. This approach may not effectively adapt to fluctuating requirements of various device operations and may result in inefficient power use and reduced battery life. Thus, a passive approach to power management may not meet the dynamic operational needs of technologies where power requirements can change based on user interactions and sensor data processing.

The present disclosure describes embodiments of a power management system for devices that can utilize an active driver system that may dynamically control power states of hardware components (also components). As described herein, the components of the device may include those within a processor such as a SoC, as well as device components including, but not limited to, cameras and sensors. Examples of sensors may include, but are not limited to, one or more accelerometers, gyroscopes, magnetometers, depth sensors, proximity sensors, eye-tracking sensors, and ambient light sensors. By way of example, consider a device comprising two SoCs, with a first SoC managing the general computing and system-wide tasks for the device, and a second SoC handling real-time data processing from the sensors and cameras. In a scenario when a user is actively engaging (e.g., this may be determined via the first SoC) with the device such that the cameras and sensors are active, both SoCs may be operating concurrently and consuming power to perform their respective tasks. Alternatively, consider a scenario where the device is on a desk, with the screen turned off, actively downloading an email. In this scenario, the primary task of retrieving email from the server may primarily involve network communication and data storage, which can be managed by the first SoC without the need for intensive sensor and/or camera data processing. Using an active driver approach, the second SoC, responsible for sensor and camera data processing, can be deactivated or powered off to conserve energy. This focused activation approach contrasts with traditional passive driver systems, where both SoCs may remain active regardless of their immediate utility. By only activating the necessary components, such as the network interface and minimal processing units of the first SoC for downloading and storing the email, unnecessary power consumption is avoided, thereby extending battery life and enhancing the efficiency of the device in comparison to a passive driver approach.

In some embodiments discussed below, by enabling individual drivers within an SoC to independently manage their respective components' power states, a battery-powered device may avoid a “thundering herd” effect, where multiple hardware components can simultaneously wake up and consume power regardless of actual need. The active driver approach may extend battery life of the battery-powered device and potentially improve overall performance by minimizing latency and enhancing responsiveness during wake events.

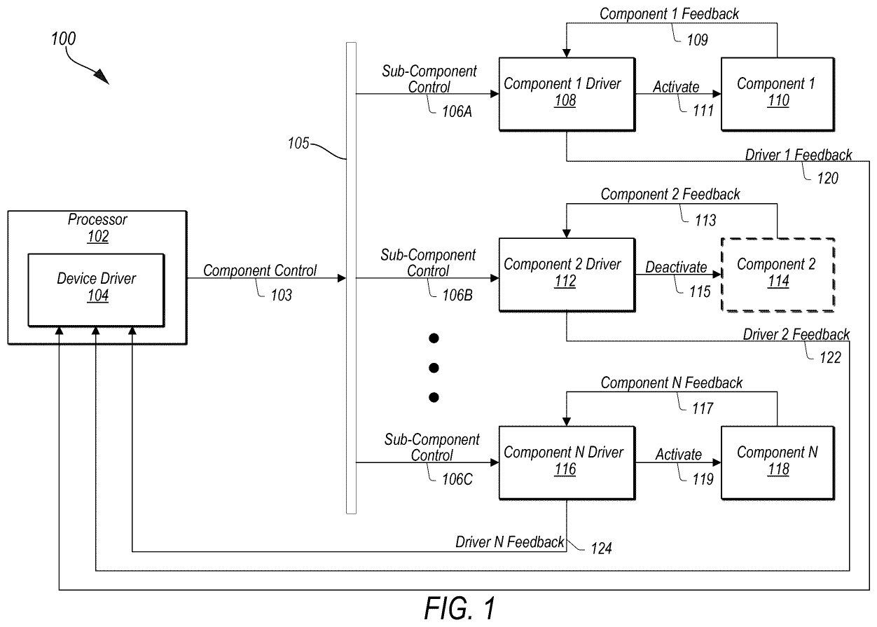

Turning now to FIG. 1, a block diagram of an active driver-based system 100 for powering and managing components within a device is depicted. In the illustrated embodiment, system 100 includes processor 102, one or more component drivers (e.g., component 1 driver 108, component 2 driver 112, through component N driver 116 representing a series of N component drivers), and corresponding components (e.g., component 1 110, component 2 114, through component N 118 representing a series of N components).

Processor 102 may correspond to any suitable processor capable of managing components in an active driver-based system. Examples of processor 102 may include, but are not limited to, a SoC, general-purpose microprocessor (GPM), application-specific integrated circuit (ASIC), digital signal processor (DSP), field-programmable gate array (FPGA), and microcontroller (MCU). Those skilled in the art will appreciate additional examples of processor 102 that may be used in an active driver-based system.

System 100 may correspond to any suitable device attempting to perform various tasks/workloads using communications between various software and/or hardware components. In some embodiments, a device is a mobile/portable device such as a phone, tablet, handheld, music player, laptop or notebook, personal data assistant (PDA), consumer device, wireless speakers, etc. In some aspects, a device is an internet of things (IoT) device, set-top box, game console, game system, server system, desktop computer, mainframe computer system, workstation, network computer, etc. In some instances, device is a wearable device such as a watch (also smartwatch), athletic sensor, augmented reality (AR) device, virtual reality (VR) device, mixed reality (MR) device, or head mounted display (HMD), which may be a headset, helmet, goggles, glasses, a phone inserted into an enclosure, etc. Those skilled in the art will appreciate additional examples of devices for implementing an active driver system as described herein.

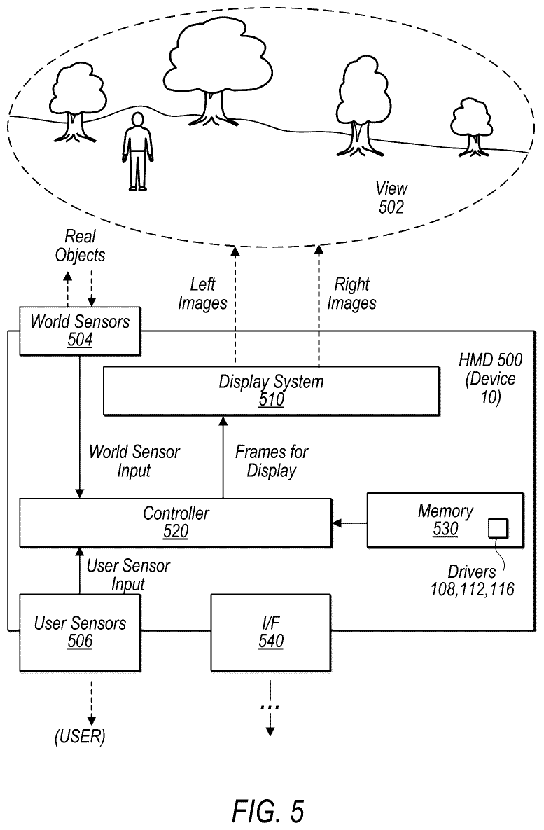

In some embodiments, processor 102 may include one or more software drivers that control and manage the overall operation of hardware within the device (e.g., the wearable device as illustrated in FIG. 5 for implementing the active driver-based system). For example, software drivers may include device driver 104 that can detect the current operational state of the device and manage the operation of the components accordingly. Examples of operational states of the device may include, but are not limited to, an active state, idle state, sleep mode, off state, low battery mode, recovery mode, and charging mode. Those skilled in the art will appreciate additional examples of operational states of a battery-powered device.

For example, consider an active state with the device fully operational and actively being used, and one or more components are turned on (e.g., device components such as cameras, microphones, sensors and corresponding SoC components communicatively coupled to them are activated). The device may have transitioned to the active state (e.g., from an off, inactive, or idle state) after device driver 104 detects a change in the operational state of the device (e.g., a user interaction such as turning the device on, wearing the device, etc.). In this example, processor 102 may then transmit a signal, component control 103, that can provide the current operational state of the device to one or more component drivers (e.g., component 1 driver 108, component 2 driver 112, through component N driver 116). In some cases, a demultiplexer 105 or any other method of signal distribution may be used to receive component control 103 and transmit sub-component control signals 106A, 106B, 106C to communicate with one or more component drivers (e.g., bits may be allocated within component control 103 signal for each sub-component control 106A, 106B, 106C signal).

In some examples, component 1 110 through component N 118 may represent any components within a processor (e.g., SoC) including, but not limited to, a central processing unit (CPU), graphics processing unit (GPU), image signal processor (ISP), power management unit (PMU), digital signal processor (DSP), neural processing unit (NPU), memory management unit (MMU), connectivity modules (e.g., network interface controller (NIC), modem, etc.), and a security processor. Those skilled in the art will appreciate additional examples of components within a processor.

The one or more components may be activated or deactivated by distributing (e.g., via demultiplexer 105, which may be implemented via an application programming interface (API), inter-process communication (IPC), shared memory, etc.) component control 103 signal to each component's corresponding driver (e.g., component 1 driver 108 for component 1 110, component 2 driver 112 for component 2 114, component N driver 116 for component N 118). By way of example, consider component 1 110 as an ISP with its corresponding component 1 driver 108, component 2 114 as a NPU with corresponding component 2 driver 112, and component N 118 as a security processor with corresponding component N driver 116. In this example, device driver 104 detects the current operational state of the device, and transmits (e.g., based on a determination that one or more components are needed for the current operational state) the current operational state of the device to one or more component drivers. Component 1 driver 108 can receive the current operational state (e.g., via signal sub-component control 106A) and may determine whether component 1 110 (e.g., an ISP) should be activated. If a determination is made by component 1 driver 108 to activate component 1 110, then component 1 driver 108 may transmit a signal to activate (e.g., as illustrated by signal 111) component 1 110. Similarly, component N driver 116 can receive the current operational state (e.g., via signal sub-component control 106C) and may determine that component N 118 (e.g., an NPU) should be activated (e.g., via signal 119). Alternatively, component 2 driver 112 can receive the current operational state (e.g., via signal sub-component control 106B) and may determine that component 2 114 should be deactivated (e.g., via signal 115). As illustrated in FIG. 1, the dashed border of component 2 114 represents a deactivated (also inactive) state.

In some aspects, the active driver-based system 100 may utilize a prewarming strategy to enhance device responsiveness by preparing components (e.g., component 1 110, component 2 114, through component N 118) in advance of anticipated use. Prewarming components before they receive data may conserve power and improve response times (e.g., latency) by minimizing the energy and time needed for activation. By way of example, processor 102 may determine a potential need based on current device interactions and contextual data. For example, consider a scenario where a user is opening an application such as a video conferencing application, and component 1 110 is a GPU configured to process image data (e.g., from a camera). In this example scenario, processor 102 may instruct (e.g., via component control 103) component 1 driver 108 to prewarm component 1 110 in anticipation of the user enabling video (e.g., one or more cameras are activated which the GPU processes data from).

In some aspects, one or more drivers as illustrated in FIG. 1 may be communicatively coupled to device driver 104. For example, each driver may transmit feedback (e.g., via driver 1 feedback 120, driver 2 feedback 122, driver N feedback 124) on the current status of their respective component. For example, component 1 driver 108 may provide a status of component 1 110, such as whether component 1 110 is activated or deactivated. In some cases, if every component driver transmits a status indicating their respective component is deactivated (i.e., turned off), then processor 102 (e.g., device driver 104) may instruct the processor (e.g., the processor comprising all the components, not illustrated in FIG. 1) to turn off, thereby conserving power of the device.

The one or more components as illustrated in FIG. 1 within an SoC may also be communicatively coupled and/or in control of one or more corresponding device components (e.g., a SoC component such as an ISP may be communicatively coupled to one or more cameras of the device, a DSP coupled to one or more microphones and one or more cameras, etc.). In some aspects, the active driver system may allow for feedback from each component to its respective driver (e.g., as illustrated by the signals component 1 feedback 109, component 2 feedback 113, component N feedback 117) that may cause the driver to active or deactivate its respective component. For example, consider a scenario where device driver 104 detects an operational state transition to an active state, and component 1 110 is an ISP for processing image/video data from one or more cameras of the device. The active state may cause device driver 104 to transmit the operational state indicating an active state to component 1 driver 108 which may consequently cause component 1 driver 108 to activate component 1 110 to process image/video data from the one or more cameras of the device. In this scenario, component 1 110 may determine from the processed image/video data that the cameras are not capturing clear data (e.g., user of the device is located in a room with no light, and cameras are not successfully capturing image/video data). Component 1 110 may then transmit a signal, component 1 feedback 109, to component 1 driver 108 instructing component 1 driver 108 to deactivate component 1 110 since the ISP does not need to be activated. In other words, in this example, although device driver 104 transmits the current operational state to component 1 driver 108 which subsequently may cause component 1 driver 108 to make a determination to activate the ISP/component 1 110 (e.g., activate due to the transition of the operational state of the device to the active state), feedback received from the ISP from its processed data may instruct its respective driver, component 1 driver 108, to deactivate. As a result, the ability for each driver to activate or deactivate its corresponding component may result in power savings and improve battery life of the device.

In some aspects, some component drivers may control (e.g., activate/deactivate) one or more components (e.g., component 1 driver 108 can activate/deactivate component 2 114, component N 118), and some components may provide feedback to one or more component drivers (e.g., component 1 110 may provide feedback to component 2 driver 112, component N driver 116). Those skilled in the art will appreciate additional implementations of an active driver-based system for powering and managing components than the example system 100 as illustrated in FIG. 1.

The active ability of components and drivers to provide feedback to higher-level control elements (e.g., device driver 104 receiving feedback 124 from component driver 116) in the tree hierarchy depicted in FIG. 1 may be described as a bottom-up approach for managing power control of various components. This approach stands in contrast to a top-down approach, such as the passive approach discussed above, in which a higher-level element (e.g., driver 104) issues an instruction to transition the operational state of one or more components without consideration of what is occurring at lower levels in the tree hierarchy.

In some embodiments, system 100 may implement a hybrid-approach in which top-down knowledge is combined with bottom-up feedback knowledge to manage power states of components. Such an approach may be advantageous when, for example, complex timing constraints and complex independencies can potentially result in a system deadlock when transitioning the power states of multiple components. For example, a driver for a display pipeline may be aware that it cannot transition a display pipeline to an inactive state until a corresponding display consuming the display pipeline output has been transitioned to an inactive state. The display pipeline driver, however, may not be aware that the display pipeline is receiving a camera stream from a camera that is expecting the display pipeline to remain operational while the camera stream is being provided. In system 100's hybrid approach, however, an element of system 100 (e.g., driver 104 or some other managing element) determines an interrelationship between a plurality of components of system 100. This interrelationship may include identified dependencies between components such as the camera (or the image signal processor (ISP) producing the camera stream) being dependent on the display pipeline. This interrelationship may include timing information such as how long it takes for particular components to transition between power states. This interrelationship may also be captured in a data structure representative of the tree hierarchy such as a graph or tree data structure. The top down knowledge captured in this determined interrelationship may then be used to diagnose potential deadlock issues—or even actively manage power states. For example, in some embodiments, in response to a driver (e.g., component driver 116) determining that a demand exists (or does not exist) for its particular component (e.g., component 118), the driver may initially request authorization from a higher-level element (e.g., driver 104) in the tree hierarchy to transition the power state of the particular component. This higher-level element may then determine whether to authorize the request based on the determined interrelationship of system components. For example, if the component is a display pipeline receiving a camera stream, the higher-level element may delay (or deny) authorizing the request until feedback has been provided indicating the camera or ISP is no longer dependent on the display pipeline.

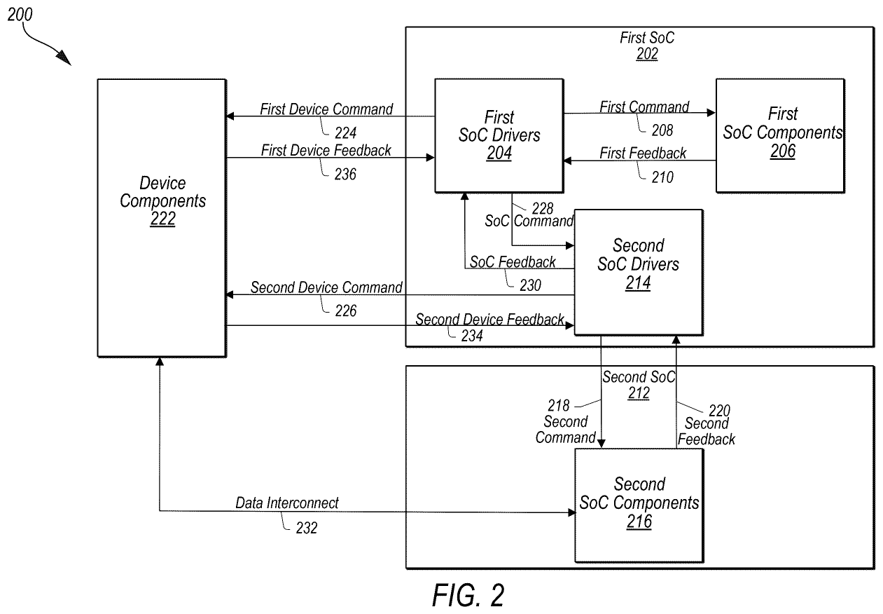

Turning now to FIG. 2, a block diagram of a dual system on a chip (SoC) configuration in a device 200 is depicted. In the illustrated embodiment, a first SoC 202 is communicatively coupled to a second SoC 212. In some aspects, first SoC 202, second SoC 212, and device components 222 are integrated or located within a device 200 (e.g., wearable device, battery-powered device).

In some instances, first SoC 202 may be a primary processor of a device 200 for handling general computing, system-wide tasks, and may act as the central hub for processing and managing the device's software and user interactions. In some cases, second SoC 212 may manage real-time data processing from one or more sensors and/or one or more cameras (e.g., one or more sensors and one or more cameras are represented by device components 222) within the device. First SoC 202 may include one or more software drivers, first SoC drivers 204, for facilitating communication and control between the operating system (OS) and first SoC components 206 of first SoC 202. In some aspects, first SoC 202 may include one or more second SoC drivers 214 capable of controlling one or more second SoC components 216 integrated within second SoC 212. First SoC components 206 and second SoC components 216 may include the examples discussed above with respect to FIG. 1.

As illustrated in FIG. 2, first SoC drivers 204 may activate and/or deactivate (e.g., via signal, first command 208) one or more first SoC components 206. First SoC components 206 may also provide feedback (e.g., via signal, first feedback 210) to first SoC drivers 204 which may cause one or more first SoC drivers 204 to activate and/or deactivate one or more first SoC components 206. Similarly, second SoC drivers 214 may activate and/or deactivate (e.g., via signal, second command 218) one or more second SoC components 216, and second SoC components 216 may also provide feedback (e.g., via signal, second feedback 220) to second SoC drivers 214 which may cause one or more second SoC drivers 214 to activate and/or deactivate second SoC components 216.

In some aspects, first SoC drivers may be communicatively coupled to second SoC drivers 214. For example, first SoC drivers 204 may transmit a signal, SoC command 228, indicating a current operational state of the device 200. Second SoC drivers 214 may then determine whether to activate and/or deactivate (e.g., via second command 218) one or more second SoC components 216 based on SoC command 228. The second SoC components 216 may provide feedback, via second feedback 220, to second SoC drivers 214 which may cause second SoC drivers 214 to activate and/or deactivate one or more second SoC components 216. In some embodiments, second SoC drivers 214 may analyze and/or process data received from second SoC components 216, which may influence their decision to activate and/or deactivate certain second SoC components 216, or second SoC drivers 214 may follow instructions directly from second SoC components 216 on whether to activate/deactivate second SoC components 216.

In some instances, one or more first SoC drivers 204 may be capable of completely deactivating or turning off second SoC 212. For example, in a scenario where all second SoC components 216 are deactivated by second SoC drivers 214 (e.g., via second command 218), second SoC drivers 214 may provide a signal, SoC feedback 230, to first SoC drivers 204 notifying first SoC drivers 204 that all second SoC components 216 are off (e.g., deactivated or in an inactive state). As a result, first SoC drivers 204 may then transmit a command (e.g., via SoC command 228) to second SoC drivers 214 to completely turn-off second SoC 212. Similarly, one or more first SoC drivers 204 may be capable of activating or turning on second SoC 212 directly (e.g., via a connection not illustrated in FIG. 2 between first SoC drivers 204 and second SoC 212, such that first SoC drivers 204 can power second SoC 212 on or off). In some embodiments, second SoC drivers 214 may provide feedback, via SoC feedback 230, to first SoC drivers 204 which may cause first SoC drivers 204 to instruct second SoC drivers 214 to turn on second SoC 212 (e.g., in order to activate one or more second SoC components 216).

As illustrated in FIG. 2, the active driver-based system may enable the activation and/or deactivation of specific components within both the first SoC 202 (e.g., first SoC components 206) and the second SoC 212 (e.g., second SoC components 216), as well as the complete activation or deactivation of the second SoC 212. This capability may facilitate enhanced power management and optimize battery usage in an example where device 200 is battery-powered.

In some cases, one or more drivers of first SoC drivers 204 and/or second SoC drivers 214 may be capable of controlling (e.g., activating and/or deactivating via signals first device command 224 and second device command 226) one or more device components 222 (e.g., sensors and/or cameras within the device 200). In some embodiments, device components 222 may provide feedback (e.g., via first device feedback 236, second device feedback 234) to first SoC drivers 204 and/or second SoC drivers 214. For example, the sensors and/or cameras may provide real-time feedback on their status or the data they are collecting and provide error reporting and diagnostics. In another example, feedback from device components 222 may inform first SoC 202 on current usage of power and computational resources. The device components 222 may be communicatively coupled (e.g., via data interconnect 232) to second SoC components 216. For example, data interconnect 232 may facilitate data communication between device components 222 (e.g., cameras, sensors) and second SoC components 216 for processing data (e.g., image/video data, sensor data). In some aspects, data interconnect 232 may enable feedback data between second SoC components 216 and device components 222.

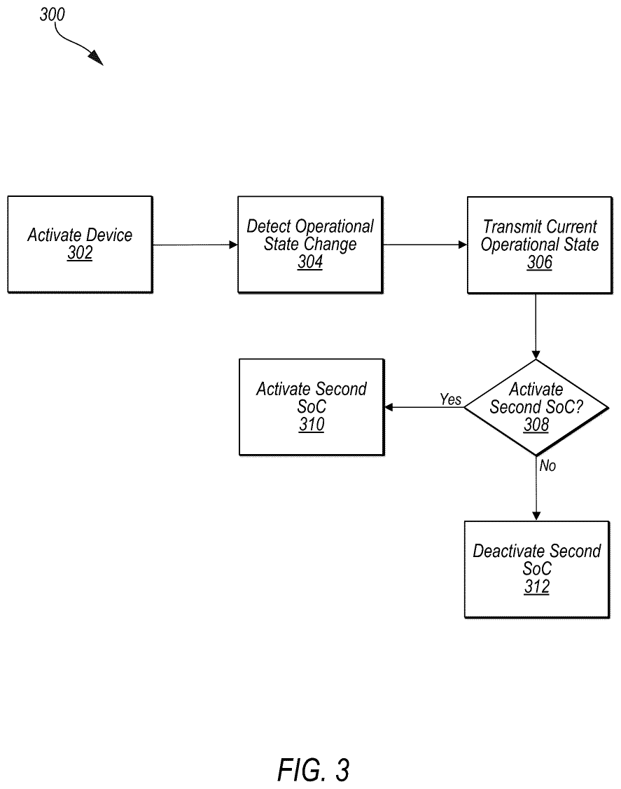

In some embodiments, a second SoC driver 214 that manages overall operation of the second SoC monitors demand for various components 216 based on feedback from other second SoC drivers 214 managing individual components 216. If this manager driver 214 determines that no demand exists for any of the components 216, the manager driver 214 can transition SoC 212 to an inactive state as will be discussed next with FIG. 3. In some instances, an errant driver 214 may incorrectly signal that a demand still exists for its particular component 216 even though that may not be the case. To prevent an errant driver 214 from preventing SoC 212 from being placed in an active state, the manager driver 214 may support an override ability to disregard any signaling from this errant driver 214. In some embodiments, the manager driver 214 can automatically determine that the feedback signal is from an errant driver and transition the second SoC 212 to an inactive state in response to determining to override the feedback signal. In some embodiments, the manager driver 214 can receive an override request to disregard the feedback signal and transition the second SoC 212 to an inactive state in response to the override request. Thus, a problematic driver 214 cannot bar second SoC 212 from transitioning to an inactive state.

Turning now to FIG. 3, a flow diagram of an example process 300 for dynamically controlling the activation of a SoC in a dual SoC system based on operational demands is depicted. In the illustrated embodiment, process 300 is performed to assess whether to activate or deactivate a second SoC in a dual SoC management system integrated within a device, thereby potentially reducing power consumption power for the device.

As shown, process 300 begins at 302 with an activation of a device (e.g., battery-powered device, wearable device, AR device, VR device, and other device examples as illustrated above with respect to FIG. 1). For example, the activation of the device, or the powering on of the device may occur in various methods. In some aspects, the methods may involve a user interaction with the device. Example methods of how a device can be activated (e.g., via a user interaction) may include, but are not limited to, a power button or switch or touchscreen (e.g., a user engages with a button, switch, or touchscreen to turn the device on), automatic power on (e.g., device powers on when plugged into a power source), peripheral interaction (e.g., connecting or disconnecting accessories or external peripherals), motion detection or orientation change (e.g., sensors such as motion sensors, accelerometers, and gyroscopes detect motion when device is picked up), voice command, proximity sensors (e.g., a wearable device detects when it is put on or when a user is near the device), biometric sensor interaction (e.g., fingerprint scan, facial recognition), scheduled alert (e.g., an alarm, calendar event, timer, may activate the device), remote control, smartphone app (e.g., application running on a smartphone, tablet PC, laptop, or any computer system configured to communicate with the device), or software updates (e.g., the device may autonomously communicate with a server to check for software updates, independent of user interaction). Those skilled in the art will appreciate additional examples of how a device can be powered on.

At 304, process 300 detects an operational state change. In some embodiments, a driver (e.g., device driver 104, first SoC drivers 204) within an SoC (e.g., processor 102, first SoC 202) detects an operational state change of the device. In some examples, the driver that detects the operational state change is integrated within the primary SoC within a dual SoC system, such as first SoC 202. For example, the device may transition between any operational state such as sleep mode, active state, off state, low battery mode, and additional examples of operational states as discussed above with respect to FIG. 1. Those skilled in the art will appreciate all the various transitions between operational states of a device.

At 306, process 300 transmits the operational state. In some embodiments, the current operational state of the device is transmitted to one or more drivers (e.g., second SoC drivers 214) that are communicatively coupled to one or more components on the second SoC. In some examples, the one or more drivers coupled to one or more components on the second SoC may be integrated into the first SoC (e.g., as illustrated in FIG. 2), or integrated into the second SoC.

At 308, process 300 determines whether to activate a second SoC. In some embodiments, one or more drivers that control components on the second SoC can receive the current operational state. If one of the drivers determines, based on the current operational state, that a second SoC component needs to be activated, then process 300 can continue to 310 to activate (e.g. or keep second SoC on if it is already active) the second SoC (e.g., via a driver on the first SoC). Alternatively, if all of the drivers that control components on the second SoC determine that none of them need to be activated, then process 300 can continue to 312 to deactivate the second SoC (e.g. or keep second SoC off if it is already inactive).

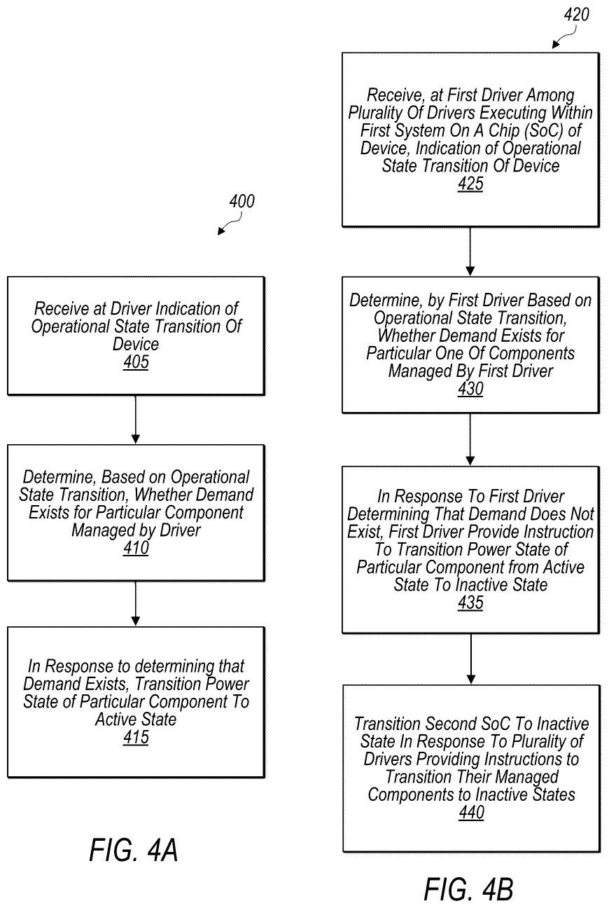

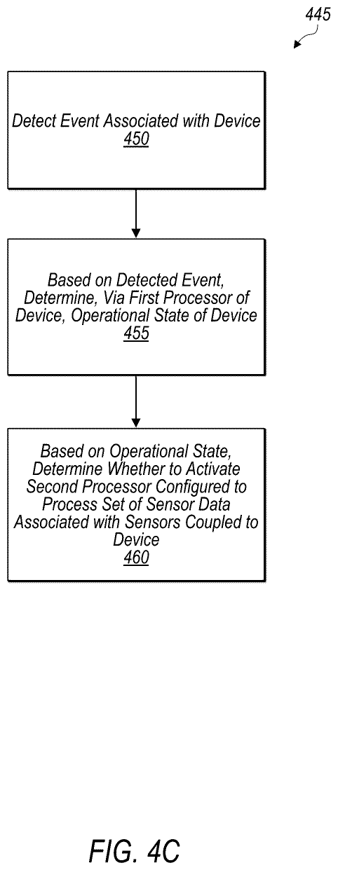

Turning now to FIG. 4A, a flow diagram of a method 400 is depicted. Method 400 is one embodiment of a method performed by a driver executable by a processor (e.g., processor 102 as illustrated in FIG. 1 and first SoC 202 as illustrated in FIG. 2) that is integrated in a device (e.g., a battery-powered device, wearable device, etc.) for powering and managing components.

In step 405, the driver receives an indication of an operational state transition of the device. For example, a driver (e.g., component 1 driver 108, component 2 driver 112, component N driver 116, second SoC drivers 214) can receive the current operational state (e.g., via component control 103, SoC command 228) of the device which may indicate a transition or change of the operational state.

In step 410, the driver determines, based on the operational state transition, whether a demand exists for a particular component managed by the driver. For example, a driver (e.g., component 1 driver 108) may determine based on the current operational state (e.g., received in step 405), whether its corresponding component (e.g., component 1 110) needs to be activated.

In step 415, in response to the driver determining that a demand exists, transitioning a power state of the particular component to an active state. For example, if a driver (e.g., component 1 driver 108) determines a demand exists for its corresponding component (e.g., component 1 110), it may transition a power state (e.g., via signal activate 111) of its component to an active state (e.g., from an inactive state or keep the component in an active state).

In some embodiments, the driver (e.g., component 1 driver 108 through component N driver 116, second SoC drivers 214) is executable by a first processor (e.g., first SoC 202) and the particular component (e.g., component 1 110 through component N 118, second SoC components 216) is within a second processor (e.g., second SoC 212). In some embodiments, the driver is further executable to receive a feedback signal from the particular component. For example, as illustrated above with respect to FIG. 1 and FIG. 2, a component may transmit data to its corresponding driver via a feedback signal (e.g., component 1 feedback 109, component 2 feedback 113, component N feedback 117). In some embodiments, the driver can transition the power state of the particular component to an inactive state based on the feedback signal. For example, the feedback signal received by a driver from its corresponding component may cause the driver to deactivate its respective component. In some embodiments, the driver is further executable to determine, based on the operational state transition, whether a network connection is needed, and wherein the particular component manages the network connection. For example, the device may transition its operational state (e.g., from idle or standby mode to active mode) and the particular component (e.g., NIC, Wi-Fi® or Bluetooth® chip, etc.) may be responsible for establishing a network connection. In some embodiments, the driver is further executable to in response to determining that the network connection is needed, transition the particular component to an active state. For example, if the particular component manages a network connection and one is needed for the operational state transition, then the driver can activate the particular component.

Turning now to FIG. 4B, a flow diagram of a method 420 is depicted. Method 420 is one embodiment of a method for powering and managing components within a device.

In step 425, method 420 includes receiving, at a first driver among a plurality of drivers executing within a first system on a chip (SoC) of a device, an indication of an operational state transition of the device, wherein the plurality of drivers manage components within a second SoC of the device. For example, both first SoC drivers 204 and second SoC drivers 214 (e.g., which can manage second SoC components 216 on a second SoC 212) can be the plurality of drivers which are integrated within a first SoC (e.g., as illustrated in FIG. 2).

In step 430, method 420 includes determining, by the first driver-based on the operational state transition, whether a demand exists for a particular one of the components managed by the first driver. For example, second SoC drivers 214 may receive the current operational state from first SoC drivers 204 (e.g., via signal SoC command 228) and determine whether a demand exists for one of its components, second SoC components 216, which are integrated within second SoC 212.

In step 435, method 420 includes in response to the first driver determining that a demand does not exist, the first driver providing an instruction to transition a power state of the particular component from an active state to an inactive state. For example, if a driver within second SoC drivers 214 determines that a demand does not exist for its corresponding component within second SoC components 216, then the driver may transition the component to an inactive state (e.g., deactivate the component, or keep the component off if it is already in an inactive state).

In step 440, method 420 includes transitioning the second SoC to an inactive state in response to the plurality of drivers providing instructions to transition their managed components to inactive states. For example, if second SoC drivers 214 instructs all the second SoC components 216 to turn off (e.g., deactivate or transition to an inactive state), then a driver within first SoC drivers 204 or second SoC drivers 214 may transition the second SoC 212 to power off.

In some embodiments, one or more sensor drivers among the plurality of drivers manage one or more sensors coupled to the second SoC. For example, one or more sensors (e.g., accelerometers, gyroscopes, magnetometers, depth sensors, proximity sensors, eye-tracking sensors, ambient light sensors, etc.) within device components 222 may be coupled to the second SoC (e.g., communicatively coupled via data interconnect 232) and managed by one or more sensor drivers (e.g., within second SoC drivers 214).

In some embodiments, method 420 includes receiving, by the first driver, an indication from one or more sensor drivers that one or more sensors have been transitioned to an inactive state. For example, one or more sensors within device components 222 may transition to an inactive state (e.g., deactivate or turn off due to a malfunction, etc.) and notify (e.g., via second device feedback 234) one or more sensor drivers (e.g., within second SoC drivers 214). The first driver (e.g., within second SoC drivers 214) that may be responsible for controlling a second SoC component 216 that utilizes data from the one or more sensors, may receive an indication from the one or more sensor drivers regarding the inactive state of the one or more sensors. In this example, consider a scenario where a sensor is an infrared sensor managed by a sensor driver, and the second component is an ISP controlled by the first driver. In this scenario, the first driver may receive an indication from the sensor driver that the infrared sensor is inactive. The first driver may then deactivate the ISP since the infrared sensor uses the infrared sensor data, but the infrared sensor is in an inactive state. In some embodiments, the same process may occur between one or more camera drivers and one or more cameras.

In some embodiments, method 420 includes prewarming, via the first SoC and prior to detecting the operational state transition, one or more of the components of the device based on a predicted need for the one or more components. As discussed above with respect to FIG. 1, prewarming may include initializing components in advance of the component being needed (e.g., a component processing data from a corresponding camera, sensor, etc.). For example, the device may initially be in an idle operational state (e.g., cameras are deactivated) while downloading a video application device. In this example, the device may predict (e.g., via the first SoC) a need for a component (e.g., GPU, ISP) that utilizes camera image/video data and prewarm the component prior to the operational state transition (e.g., prewarming may occur prior to the device changing operational states, such as from an idle state to an active state). Prewarming one or more components may help reduce latency when transitioning to different operational states.

Turning now to FIG. 4C, a flow diagram of a method 445 is depicted. Method 445 is another embodiment of a method for powering and managing components within a device.

In step 450, method 445 includes detecting an event associated with a device. For example, an event may be a user interaction with the device via a physical input (e.g., body, face, and eye gesturing), voice command, orientation change (e.g., the user may move the device), peripheral interaction, physical buttons, touch screen, biometric sensor interaction, and proximity sensor interaction. In another example, an event may be the device autonomously initiating a communication with a server to check for one or more software updates (e.g., the device may receive software updates for OS, firmware, security patches, application updates, driver updates, etc.) Those skilled in the art will appreciate additional methods of an event associated with a device.

In step 455, method 445 includes, based on the detected event, determining, via a first processor of the device, an operational state of the device. For example, after the device is powered on, the first SoC may detect (e.g., via device driver 104) the current operational state of the device.

In step 460, method 445 includes determining, based on the operational state, whether to activate a second processor coupled to the device, wherein the second processor is configured to process a set of sensor data associated with one or more sensors coupled to the device. For example, the first SoC may transmit the operational state of the device to the drivers that manage the components on the second SoC which may subsequently make a determination on whether to activate the second SoC (e.g., if one or more second SoC components need to be activated, then the second SoC can be activated or turned on).

In some embodiments, the event is caused by one or more push notifications. Examples of push notifications may include, but are not limited to, app notifications, message alerts (e.g., text messages), event alerts, calendar alerts, personal note alerts, and system updates (e.g., a notification from the OS of the device to update the device's system software).

### Exemplary Computer System

Turning now to FIG. 5, a block diagram of components within a wearable device (e.g., dual SoC management system for dynamic control of component power states) as discussed above (or device 10), is depicted. In the illustrated embodiment, computing device 500 is depicted as a head-mounted display (HMD) configured to be worn on the head and to display content, such as an extended reality (XR) view 502 of an XR environment, to a user. For example, HMD 500 may be a headset, helmet, goggles, glasses, a phone inserted into an enclosure, etc. worn by a user. Computing device 500, however, may correspond to other devices in other embodiments, which may (or may not) be presenting XR content. In the illustrated embodiment, HMD 500 includes world sensors 504, user sensors 506, a display system 510, controller 520, memory 530, and a network interface 540. In some embodiments, HMD 500 may be implemented differently than shown. For example, HMD 500 may include multiple interfaces 540, controller 520 may be implemented using multiple processors, etc.

World sensors 504 are sensors configured to collect various information about the environment in which a user wears HMD 500. In some embodiments, world sensors 504 may include one or more visible-light cameras that capture video information of the user's environment. This information also may, for example, be used to provide a view 502 (which may be an extended reality (XR) view of the real environment), detect objects and surfaces in the environment, provide depth information for objects and surfaces in the real environment, provide position (e.g., location and orientation) and motion (e.g., direction and velocity) information for the user in the real environment, etc. In some embodiments, HMD 500 may include left and right cameras located on a front surface of the HMD 500 at positions that are substantially in front of each of the user's eyes. In other embodiments, more or fewer cameras may be used in HMD 500 and may be positioned at other locations.

In some embodiments, world sensors 504 may include one or more world mapping sensors (e.g., infrared (IR) sensors with an IR illumination source, or Light Detection and Ranging (LIDAR) emitters and receivers/detectors) that, for example, capture depth or range information for objects and surfaces in the user's environment. This range information may, for example, be used in conjunction with frames captured by cameras to detect and recognize objects and surfaces in the real-world environment, and to determine locations, distances, and velocities of the objects and surfaces with respect to the user's current position and motion. The range information may also be used in positioning virtual representations of real-world objects to be composited into an XR environment at correct depths. In some embodiments, the range information may be used in detecting the possibility of collisions with real-world objects and surfaces to redirect a user's walking. In some embodiments, world sensors 504 may include one or more light sensors (e.g., on the front and top of HMD 500) that capture lighting information (e.g., direction, color, and intensity) in the user's physical environment. This information, for example, may be used to alter the brightness and/or the color of the display system in HMD 500.

User sensors 506 are sensors configured to collect various information about a user wearing HMD 500. In some embodiments, user sensors 506 may include one or more head pose sensors (e.g., IR or RGB cameras) that may capture information about the position and/or motion of the user and/or the user's head. The information collected by head pose sensors may, for example, be used in determining how to render and display views 502 of the XR environment and content within the views. For example, different views 502 of the environment may be rendered based at least in part on the position of the user's head, whether the user is currently walking through the environment, and so on. As another example, the augmented position and/or motion information may be used to composite virtual content into the scene in a fixed position relative to the background view of the environment. In some embodiments there may be two head pose sensors located on a front or top surface of the HMD 500; however, in other embodiments, more (or fewer) head-pose sensors may be used and may be positioned at other locations.

In some embodiments, user sensors 506 may include one or more eye tracking sensors (e.g., IR cameras with an IR illumination source) that may be used to track position and movement of the user's eyes. In some embodiments, the information collected by the eye tracking sensors may be used to adjust the rendering of images to be displayed, and/or to adjust the display of the images by the display system of the HMD 500, based on the direction and angle at which the user's eyes are looking. In some embodiments, one or more of these eye tracking sensors may be used to implement a biosensor for biometrically authenticating a user. In some embodiments, the information collected by the eye tracking sensors may be used to match direction of the eyes of an avatar of the user to the direction of the user's eyes. In some embodiments, brightness of the displayed images may be modulated based on the user's pupil dilation as determined by the eye tracking sensors. In some embodiments, user sensors 506 may include one or more eyebrow sensors (e.g., IR cameras with IR illumination) that track expressions of the user's eyebrows/forehead. In some embodiments, user sensors 506 may include one or more lower jaw tracking sensors (e.g., IR cameras with IR illumination) that track expressions of the user's mouth/jaw. For example, in some embodiments, expressions of the brow, mouth, jaw, and eyes captured by sensors 506 may be used to simulate expressions on an avatar of the user in a co-presence experience and/or to selectively render and composite virtual content for viewing by the user based at least in part on the user's reactions to the content displayed by HMD 500.

In some embodiments, user sensors 506 may include one or more hand sensors (e.g., IR cameras with IR illumination) that track position, movement, and gestures of the user's hands, fingers, and/or arms. For example, in some embodiments, detected position, movement, and gestures of the user's hands, fingers, and/or arms may be used to simulate movement of the hands, fingers, and/or arms of an avatar of the user in a co-presence experience. As another example, the user's detected hand and finger gestures may be used to determine interactions of the user with virtual content in a virtual space, including but not limited to gestures that manipulate virtual objects, gestures that interact with virtual user interface elements displayed in the virtual space, etc.

Display system 510 is configured to display rendered frames to a user. Display 510 may implement any of various types of display technologies. For example, as discussed above, display system 510 may include near-eye displays that present left and right images to create the effect of three-dimensional view 502. In some embodiments, near-eye displays may use digital light processing (DLP), liquid crystal display (LCD), liquid crystal on silicon (LCoS), or light-emitting diode (LED). As another example, display system 510 may include a direct retinal projector that scans frames including left and right images, pixel by pixel, directly to the user's eyes via a reflective surface (e.g., reflective eyeglass lenses). To create a three-dimensional effect in view 502, objects at different depths or distances in the two images are shifted left or right as a function of the triangulation of distance, with nearer objects shifted more than more distant objects. Display system 510 may support any medium such as an optical waveguide, a hologram medium, an optical combiner, an optical reflector, or any combination thereof. In some embodiments, display system 510 may be transparent or translucent and be configured to become opaque selectively.

Controller 520 includes circuitry configured to facilitate operation of HMD 600. Accordingly, controller 520 may include one or more processors configured to execute program instructions to cause HMD 500 to perform various operations described herein such as those associated with first SoC 202 and/or second SoC 212. These processors may be CPUs configured to implement any suitable instruction set architecture and may be configured to execute instructions defined in that instruction set architecture. For example, in various embodiments controller 520 may include general-purpose or embedded processors implementing any of a variety of instruction set architectures (ISAs), such as ARM, x86, PowerPC, SPARC, RISC, or MIPS ISAs, or any other suitable ISA. In multiprocessor systems, each of the processors may commonly, but not necessarily, implement the same ISA. Controller 520 may employ any microarchitecture, including scalar, superscalar, pipelined, superpipelined, out of order, in order, speculative, non-speculative, etc., or combinations thereof. Controller 520 may include circuitry to implement microcoding techniques. Controller 520 may include one or more levels of caches, which may employ any size and any configuration (set associative, direct mapped, etc.).

In some embodiments, controller 520 may include a GPU, which may include any suitable graphics processing circuitry. Generally, a GPU may be configured to render objects to be displayed into a frame buffer (e.g., one that includes pixel data for an entire frame). A GPU may include one or more graphics processors that may execute graphics software to perform a part or all of the graphics operation, or hardware acceleration of certain graphics operations. In some embodiments, controller 520 may include one or more other components for processing and rendering video and/or images, for example image signal processors (ISPs), coder/decoders (codecs), etc. In some embodiments, controller 520 may be implemented as a system on a chip (SOC).

Memory 530 is a non-transitory computer readable medium configured to store data and program instructions executed by processors in controller 520 such as those facilitating the authentication techniques described herein. Memory 530 may include any type of volatile memory, such as dynamic random-access memory (DRAM), synchronous DRAM (SDRAM), double data rate (DDR, DDR2, DDR3, etc.) SDRAM (including mobile versions of the SDRAMs such as mDDR3, etc., or low power versions of the SDRAMs such as LPDDR2, etc.), RAMBUS DRAM (RDRAM), static RAM (SRAM), etc. Memory 530 may also be any type of non-volatile memory such as NAND flash memory, NOR flash memory, nano RAM (NRAM), magneto-resistive RAM (MRAM), phase change RAM (PRAM), Racetrack memory, Memristor memory, etc. In some embodiments, one or more memory devices may be coupled onto a circuit board to form memory modules such as single inline memory modules (SIMMs), dual inline memory modules (DIMMs), etc. Alternatively, the devices may be mounted with an integrated circuit implementing system in a chip-on-chip configuration, a package-on-package configuration, or a multi-chip module configuration.

Network interface 540, in various embodiments, includes one or more interfaces configured to communicate with external entities. Network interface 540 may support any suitable wireless technology such as Wi-Fi®, Bluetooth®, Long-Term Evolution™, etc. or any suitable wired technology such as Ethernet, Fibre Channel, Universal Serial Bus™ (USB) etc. In some embodiments, network interface 540 may implement a proprietary wireless communications technology (e.g., 90 gigahertz (GHz) wireless technology) that provides a highly directional wireless connection. In some embodiments, HMD 500 may select between different available network interfaces based on connectivity of the interfaces as well as the particular user experience being delivered by HMD 500. For example, if a particular user experience requires a high amount of bandwidth, HMD 500 may select a radio supporting the proprietary wireless technology when communicating wirelessly to stream higher quality content. If, however, a user is merely a lower-quality movie, Wi-Fi® may be sufficient and selected by HMD 500. In some embodiments, HMD 500 may use compression to communicate in instances, for example, in which bandwidth is limited.

The present disclosure includes references to “an embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . W, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” or is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation-[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of tasks or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), functional unit, memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

What is claimed is:

1. A device, comprising:
one or more processors;
memory having program instructions stored thereon that are executable by the one or more processors, wherein the program instructions include a driver executable to:
receive an indication of an operational state transition of the device;
determine, based on the operational state transition, whether a demand exists for a particular component managed by the driver; and
in response to determining that a demand exists, transition a power state of the particular component to an active state.

2. The device of claim 1, wherein the driver is executable by a first of the one or more processors to control the particular component; and
wherein the particular component is within a second of the one or more processors.

3. The device of claim 1, wherein the driver is further executable to:
receive, from the particular component, a feedback signal indicative of a demand associated with the particular component; and
based on the feedback signal, transition the power state of the particular component.

4. The device of claim 1, wherein the driver is further executable to:
receive, from the particular component, a first feedback signal indicative of a demand associated with the particular component; and
based on the first feedback signal, provide a second feedback signal to a second driver to cause the second driver to alter a power state of a second particular component.

5. The device of claim 1, wherein the received indication identifies an operational state transition associated with establishing a network connection; and
wherein the driver is further executable to:
in response to the particular component being associated with the network connection, transition a power state of the particular component to an active state.

6. The device of claim 1, wherein the received indication identifies an operational state transition associated with a time triggered event; and
wherein the driver is further executable to:
determine whether to transition a power state of the particular component based on a relevance of the particular component to the time triggered event.

7. The device of claim 1, wherein the received indication identifies an operational state transition associated with a user interaction; and
wherein the driver is further executable to:
determine whether to transition a power state of the particular component based on a relevance of the particular component to the user interaction.

8. The device of claim 1, wherein the received indication identifies an operational state transition associated with reception of a push notification; and
wherein the driver is further executable to:
determine whether to transition a power state of the particular component based on a relevance of the particular component to the reception.

9. The device of claim 1, wherein the driver is further executable to:
predict, based on the operational state transition, that a demand is likely to exist for the particular component; and
prewarm the particular component based on the predicted demand.

10. The device of claim 1, wherein the program instructions are further executable to:
determine an interrelationship between a plurality of components of the device, wherein the plurality of components includes the particular component; and
in response to the driver determining whether a demand exists for the particular component, determine, based on the interrelationship, whether to authorize the driver to transition the power state of the particular component.

11. A method, comprising:
receiving, at a first driver among a plurality of drivers executing within a first system on a chip (SoC) of a device, an indication of an operational state transition of the device, wherein the plurality of drivers manage components associated with a second SoC of the device;
determining, by the first driver based on the operational state transition, whether a demand exists for a particular one of the components managed by the first driver;
in response to the first driver determining that a demand does not exist, the first driver providing an instruction to transition a power state of the particular component from an active state to an inactive state; and
transitioning the second SoC to an inactive state in response to the plurality of drivers providing instructions to transition their managed components to inactive states.

12. The method of claim 11, further comprising:
in response to one of the plurality of drivers determining that a demand exists for a component managed by the driver, transitioning the second SoC from an inactive state to an active state.

13. The method of claim 11, wherein the transitioning includes:
receiving, at a manager driver that manages the second SoC and executes on the first SoC, feedback signals from ones of the plurality of drivers indicating that a demand does not exist for the components associated with the second SoC; and
transitioning, by the manager driver, the second SoC to an inactive state based on the feedback signals.

14. The method of claim 11, wherein the transitioning includes:
receiving, at a manager driver that manages the second SoC and executes on the first SoC, a feedback signal from one of a plurality of drivers indicating that a demand exists for one of the managed components;
determining, by the manager driver, that the feedback signal is from an errant driver; and
transitioning, by the manager driver, the second SoC to an inactive state in response to determining to override the feedback signal.

15. The method of claim 11, wherein the transitioning includes:
receiving, at a manger driver that manages the second SoC and executes on the first SoC, a feedback signal from one of a plurality of drivers indicating that a demand exists for one of the managed components;
receiving, by the manager driver, an override request to disregard the feedback signal; and
transitioning, by the manager driver, the second SoC to an inactive state in response to the override request.

16. The method of claim 11, wherein the transitioning includes ones of the plurality of drivers providing feedback signals to a driver that manages the second SoC to cause the driver to transition the second SoC to the inactive state.

17. The method of claim 11, wherein the managed components include an accelerometer, a gyroscope, a magnetometer, a depth sensor, a proximity sensor, an eye-tracking sensor, or an ambient light sensor.

18. A non-transitory computer readable medium having program instructions stored thereon that are executable by a device to perform operations comprising:
detecting an event associated with the device;
based on the detected event, determining, via a first processor of the device, an operational state of the device; and
based on the operational state, determining whether to activate a second processor coupled to the device, wherein the second processor is configured to process a set of sensor data associated with one or more sensors coupled to the device.

19. The computer readable medium of claim 18, wherein the operations further comprise:
in response to determining to activate the second processor, determining, by one or more drivers executing on the first processor, whether to activate the one or more sensors managed by the one or more drivers.

20. The computer readable medium of claim 18, wherein the operations further comprise:
in response to determining to activate the second processor:
predicting, by a driver executing on the first processor, that a demand is likely to exist for one of the one or more sensors; and
prewarming the sensor including transitioning the sensor to an active state prior to a request to use the sensor being received.
